(19) United States
(12) Patent Application Publication
(10) Pub. No.: US 2021/0095497 A1
(43) Pub. Date: Apr. 1, 2021

(54) Handle Device for a Door or a Lid

(71) Applicant: Huf Hülsbeck & Fürst GmbH & Co. KG, Velbert (DE)

(72) Inventors: Markus Bartels, Mülheim (DE); Andreas Niegeloh, Solingen (DE); Thomas Kittel, Velbert (DE); Alexander Fromme, Velbert (DE)

(21) Appl. No.: 17/041,190

(22) PCT Filed: Feb. 28, 2019
(86) PCT No.: PCT/EP2019/054980

§ 371 Date: Sep. 24, 2020

(30) Foreign Application Priority Data
Mar. 28, 2018 (DE) 10 2018 107 503.0

(51) Int. Cl. E05B 79/06; E05B 81/76; E05B 85/10

(52) U.S. Cl. CPC E05B 79/06; E05B 85/10; E05B 81/76

(57) ABSTRACT

The invention relates to a handle device (1) for a movable part, in particular a door or a lid, of a motor vehicle, which is designed with a, in particular fixed, handle part (10) for actuating the movable part, and a carrier element (20) for fixing the handle part (10) to the movable part.

The invention relates to a handle device for a movable part, in particular a door or a lid, of a motor vehicle according to the preamble of the independent device claim, which is designed with a, in particular fixed, handle part for actuating the movable part and a carrier element for fixing the handle part to the movable part. Furthermore, the invention relates to a method for assembling a corresponding handle device according to the preamble of the independent method claim.

Handle devices for motor vehicle doors are generally known, e.g. from the document DE 10 2007 027 845 A1. Known handle devices are usually designed with a handle part for actuating a motor vehicle door and a carrier element for fixing the handle part to the motor vehicle door. In order to fix the handle part to the carrier element, several complicated assembly steps must often be performed until the handle part is arranged in a correct position on the carrier element and can finally be fixed. Such handle devices are therefore complex in the assembly.

The object of the present invention is therefore to provide a handle device for a movable part, in particular a door or a lid, of a motor vehicle, which at least partially overcomes the above mentioned disadvantages. In particular, it is an object of the present invention to create a handle device which is simply constructed and which can be easily, quickly and precisely assembled on the movable part. Furthermore, a method for the assembly of such a handle device shall be provided. In particular, the method shall enable the assembly of the handle device to be improved, preferably simplified.

The present object is solved by a handle device with the features of the independent device claim, in particular from the characterizing portion. Likewise, for the solution of the object a method for the assembly of a door handle system with the features of the independent method claim, in particular from the characterizing portion, is suggested. The dependent device and method claims show preferred further developments of the invention. Features that are disclosed for the individual embodiments of the inventive handle device and the inventive method can be combined with each other in such a way that with respect to the disclosure for the embodiments of the inventive handle device and the inventive method reference is or can always be made to each other. Furthermore, the method according to the invention can be performed for the assembly of the handle device according to the invention.

The handle device according to the invention for a movable part, in particular a door or a lid, of a motor vehicle is designed with a, in particular fixed, handle part for actuating the movable part and a carrier element for fixing the handle part to the movable part. According to the invention, at least one guiding unit is provided between the handle part and the carrier element in order to guide the handle part in a form-locking manner at the assembly on the carrier element.

The device according to the invention can be used on a motor vehicle door from the driver's side as well as from the passenger's side and on rear motor vehicle doors or a trunk lid. The carrier element can be understood as any part in relation to the movable part for the assembly of the handle part.

The idea of the invention lies in the fact that a guiding unit is created in the handle device, which enables a form-locking guide of the handle part on the carrier element at the assembly. According to the invention, a form-locking guide is called a controlled guide in a predetermined track created by the guiding unit. The guiding unit according to the invention provides the installer with a tactile feedback about a correct insertion movement of the handle part into the carrier element. Thus, the insertion movement of the handle part into the carrier element can be executed intuitively and haptically comprehensible. Furthermore, the guiding unit enables the correct position of the handle part on the carrier element to be adjusted quickly, precisely and easily controlled. Thus, the assembly of the handle device according to the invention can be performed easily, quickly, safely and correctly.

Furthermore, it may be provided within the scope of the invention that the guiding unit can form a linear guide for the handle part at the assembly on the carrier element. The linear guide can be provided for at least one end, in particular for both ends, of the handle part. Such a linear guiding unit can significantly improve the assembly of the handle part on the carrier element. The handle part can be easily inserted into the carrier element in only one assembling step and with the help of only one insertion movement in the correct direction. To do this, the installer must position the handle part with the handle body parallel to the surface of the movable part and then insert the handle part on the carrier element with both ends simultaneously in only one linear insertion movement towards the surface of the movable part. At least one end, in particular both ends, of the handle part can be received in a form-locking manner in the carrier element. Such an insertion movement of the handle part enables a simple, intuitive and easily controllable assembly of the handle device on the movable part. The correctness of the assembly can be advantageously recognized by the installer by tactile means, if the handle part is received in a form-locking manner in the, preferably linear, guide.

Furthermore, the invention may provide that the handle part may comprise a first holding means and a second holding means at opposite ends over its longitudinal extension. Advantageously, the handle part can interact mechanically with the carrier element via the first holding means and via the second holding means for fixing. The handle part can interact mechanically with the carrier element for fixing due to corresponding openings as bearing positions that can be provided in the carrier element in which the first holding means and the second holding means can be received, preferably in a form-locking manner. In addition, the first holding means and the second holding means can be linear and form a part of the guiding unit. It is conceivable that the first holding means and the second holding means can be designed as linear protruding projections at the opposite ends of the handle part. The first holding means and the second holding means can protrude in the same direction from the handle part and be aligned essentially parallel to each other. In addition, it is conceivable that the first holding means and the second holding means can be aligned in such a way that they can be received in the carrier element essentially perpendicular to the extension direction of the carrier element. With the help of such holding means not only can the handle part be designed in a simple and cost-effective way, but also the construction of the entire handle device, including the carrier element for receiving the holding means, can be simplified. Another advantage is that the first holding means and the second holding means can form a part of the guiding unit. Thus, the first holding means and the second holding means can advantageously not only contribute to the fixing of the handle part to the carrier element, but also to a simple, controllable and precise assembly.

The handle part and/or the carrier element can be designed as an injection molded part, in particular as a plastic injection molded part, which allows a mass production with high and constant quality. The guiding unit in particular can be provided with an additional coating to reduce friction, in particular at the assembly of the handle part. Furthermore, an electronic unit may be arranged in a recess or cavity at least in the handle part or on the carrier element, wherein the ease of operation of the handle device according to the invention can be improved overall.

Furthermore, it may be provided within the scope of the invention that the carrier element may comprise a first bearing position for the first holding means of the handle part and a second bearing position for the second holding means of the handle part. Advantageously, the first bearing position and the second bearing position can be used for the mechanical fixing of the handle part to the carrier element. In addition, the first bearing position and the second bearing position can form a part of the guiding unit. This comprises the advantage that the functionality of the handle device can be extended with only a few means, wherein the first bearing position and the second bearing position as a part of the guiding unit can not only contribute to the fixing of the handle part to the carrier element, but also to an easy, fast and safe assembly of the handle device to the movable part.

Furthermore, it may be provided within the scope of the invention that the guiding unit may comprise at least one assembling means on the first holding means and/or on the second holding means of the handle part. Advantageously, the assembling means can be designed for producing a form-locking guide of the handle part in the carrier element or the holding means of the handle part in the bearing positions of the carrier element. It is also conceivable that the assembling means can be designed in the form of a rib and/or a guiding receptacle. Such an assembling means is easy to produce and requires only a simple connecting partner for a form-locking guide according to the invention. Although it is conceivable that the holding means on the handle part can be designed as a whole corresponding to the openings at the bearing positions of the carrier element in order to realize a form-locking guide, a form-locking guide is easier and more reliable to realize with a specially designed assembling means. This is because the holding means as a whole can be designed with a certain clearance to the openings at the bearing positions in order to counteract tolerances in the production of the elements of the handle device or as a result of material properties. Furthermore, it is advantageous that the assembling means in the form of a rib and/or a guiding receptacle can define the correct insertion direction of the handle part into the carrier element by the extension direction of the rib and/or the projection. Only if the handle part is inserted correctly into the carrier element along the extension direction of the rib and/or the projection, the assembling means can be displaced in the carrier element or in a correspondingly designed bearing position. Advantageously, the assembling means prevents a tilting or a tilted insertion of the handle part into the carrier element. Thus, when inserting the handle part into the carrier element, the installer can haptically receive a feedback whether the insertion direction of the handle part into the carrier element is correct.

Furthermore, within the scope of the invention, it is possible that the guiding unit can comprise at least one guiding means at the first bearing position and/or at the second bearing position of the carrier element, wherein in particular the guiding means can be designed as a corresponding means for the assembling means in order to produce a form-locking connection of the handle part with the carrier element. It is advantageous for the guiding means to serve as a connection partner to the assembling means when producing a form-locking guide of the handle part in the carrier element or the holding means of the handle part in the bearing positions of the carrier element. It is also conceivable that the guiding means can be designed in the form of a guiding receptacle or a guiding rail. Such an assembling means is easy to produce. In addition, the guiding means in the form of a guiding receptacle or a guiding rail can advantageously specify a preferably linear insertion direction of the handle part into the carrier element with the aid of the assembling means. This makes it easier to fix the handle part to the carrier element.

Furthermore, the invention may provide that the assembling means may comprise a bore on the first holding means and/or on the second holding means of the handle part, which may serve as a cable holder. The bore can extend along the assembling means and can receive different cables in a protected and bundled manner. The cables may lead to different sensors on the handle part, which may be provided to actuate the movable part. Thus, the assembling means can not only ensure a form-locking guide of the handle part in the carrier element, but also fulfill another important function, namely to enable a bundled, protected guidance of cables from the inside of the handle device behind the movable part to the outside handle part. This also allows the construction of the handle device to be considerably simplified, while at the same time significantly improving the functionality of the handle device.

Furthermore, the guiding unit can comprise at least one engaging means on the first holding means and/or on the second holding means of the handle part in order to fix an end assembling position of the handle part on the carrier element in a form- and/or force-locking manner. Thus, the installer can recognize the correct end assembling position of the handle part on the carrier element, as the engaging means can provide a clear tactile feedback to the installer when reaching the end assembling position. It is also conceivable that the engaging means is designed in the form of an engaging cam and/or an engaging receptacle. Thus, the engaging means can be easily configured. In addition, the engaging means can interact with a simple complementary connecting partner to fix the end assembling position of the handle part to the carrier element in a form- and/or force-locking manner. Furthermore, it is advantageous that the engaging means can generate a certain guiding resistance when the handle part is inserted into the carrier element shortly before the end assembling position is reached. In order to reach this end assembling position, the installer must once again overcome the small guiding resistance generated by the engaging means. Based on the tactile feedback, the installer finally knows that he has reached the correct end assembling position. Finally, the installer can mechanically secure the handle part in the end assembling position, for example with a securing element that can prevent the handle part from being pulled out of the carrier element by force.

Furthermore, it is conceivable that the guiding unit may comprise at least one fixing means at the first bearing position and/or at the second bearing position of the carrier element, wherein in particular the fixing means may be designed as a corresponding means to the engaging means in order to produce a form- and/or force-locking connection with the engaging means in the end assembling position of the handle part on the carrier element. Advantageously, the fixing means can be designed complementary to the engaging means in order to fix the end assembling position of the handle part on the carrier element in a form- and/or force-locking manner. It is conceivable here that the fixing means can be designed in the form of a fixing receptacle and/or a fixing cam. Such a fixing means is easy to form and can fix the end assembling position of the handle part on the carrier element in combination with a corresponding engaging means.

Furthermore, it is possible for the guiding unit to comprise at least one pre-engaging means on the first holding means and/or on the second holding means of the handle part and/or on the first bearing position and/or on the second bearing position of the carrier element in order to guide the fixing means on the first bearing position and/or on the second bearing position of the carrier element and/or the engaging means on the first holding means and/or on the second holding means of the handle part in a form-locking manner at the assembly of the handle part on the carrier element before the end assembling position of the handle part on the carrier element is reached. Thus, the advantage can be achieved that during the insertion movement of the handle part into the carrier element, the engaging means at the first holding means and/or at the second holding means of the handle part and/or the fixing means at the first bearing position and/or at the second bearing position of the carrier element do not disturb a form-locking guide of the handle part at the carrier element by the guiding unit at first. Shortly before reaching an end assembling position of the handle part on the carrier element, the pre-engaging means can end so that a guiding resistance for the engaging means and/or for the fixing means is created. In the end assembling position, the engaging means and the fixing means are brought into a form-and/or force-locking connection, which causes the guiding resistance to dissipate and a haptic feedback to the installer can be generated, which can mark the end assembling position.

Furthermore, it may be provided within the scope of the invention that the handle part, in particular the first holding means and/or the second holding means of the handle part, may comprise at least one connecting means which can interact with a securing element in order to secure the handle part in an end assembling position of the handle part on the carrier element. In the end assembling position, the handle part is initially held on the carrier element by the engaging means and the fixing means, which create a form- and/or force-locking connection with one another. The form- and/or force-locking connection between the engaging means and the fixing means can be released and the handle part can be removed from the carrier element by a forced pulling or by centrifugal forces, which can occur, for example, at high accelerations, which can act in the opposite direction to the insertion direction of the handle part on the carrier element. In order to prevent this, the handle part can be secured in the end assembling position by the securing element in a form- and/or force-locking manner, wherein the created form- and/or force-lock can preferably act perpendicular to the insertion direction of the handle part along the form-locking guide of the guiding unit. The securing element can extend essentially along the handle part. By displacing the securing element along the handle part, it can engage in the connecting means on the first holding means and/or on the second holding means of the handle part, so that a movement of the handle part perpendicular to the extension direction of the securing element is no longer possible because the securing element is in the way of such a movement. Consequently, the securing element can advantageously prevent the handle part from being pulled back along the form-locking guide of the guiding unit created for the assembly without authorization and/or unintentionally.

Advantageously, a securing element may be provided within the scope of the invention, which may serve to secure the handle part in an end assembling position on the carrier element, in particular by at least one connecting means on the handle part. It is conceivable that the securing element may be designed in one part in the form of a securing plate and/or in another part of a securing fork. The securing fork can be designed advantageously to receive and form- and/or force-locking secure the handle part. The securing plate can be assembled particularly easily and securely on the carrier element and can generate a high normal force to prevent the handle part from being pulled out of the carrier element. Thus, the handle part can be secured particularly easily and reliably in the end assembling position. For the reception of the securing element in the carrier element, a flat elongated receptacle can be provided in which the securing element can be arranged longitudinally displaceable, in particular along its extension direction. In addition, it is conceivable that the securing element can be arranged in the carrier element in such a way that it can be moved longitudinally by means of an adjusting screw. By tightening the screw, the securing element can be easily moved to secure the handle part in the end assembling position against being pulled out. Thus, a simply designed handle device can be created which is safe in operation and can also be easily assembled.

Furthermore, a locking cylinder can be provided on the carrier element to mechanically actuate the movable part. In this way, an authorized user can be given the possibility to open or close the movable part mechanically.

Advantageously, a reinforcing element for the locking cylinder can be provided on the handle part to protect the locking cylinder against mechanical manipulation. The reinforcing element can create a mechanical reinforcement around the locking cylinder in an externally accessible region on the handle part. This can be advantageously used to provide a burglary protection for the motor vehicle. It is conceivable that the reinforcing element can be designed in the form of a solid collar element for the locking cylinder, for example from a material with a high hardness, such as cast iron. Such a reinforcing element cannot easily be sawn or damaged in any way. Thus, the locking cylinder can be reliably protected against unauthorized manipulation, which can be performed from the outside of the handle part by an unauthorized person.

It is further conceivable that the handle device may be designed as a part of a locking system of the motor vehicle, in particular a keyless-go system or a keyless-entry system, wherein preferably at least one sensor element, preferably on the handle part, may be provided in order to electronically actuate the movable part. According to both alternatives the sensor element can be designed accordingly, e.g. as a contactless proximity sensor, a capacitive sensor or the like. Furthermore, it is conceivable that a security system for the locking system or at least one electronic unit for this purpose (as already mentioned) with a corresponding transmission and receiving unit for an identification request may be integrated completely or partially in the handle device, in particular in the handle part. An advantage is that such a locking system can automatically open and/or close the vehicle door during normal operation of the handle device without a mechanical locking cylinder if corresponding sensors in or on the door handle have been activated. Thus, a fully automated locking system for a motor vehicle, preferably with a fixed handle part, can be provided.

Furthermore, the object according to the invention is solved by a method for assembling a handle device for a movable part, in particular a door or a lid, of a motor vehicle, which may be designed with a handle part for actuating the movable part and a carrier element for fixing the handle part to the movable part. According to the invention, it is provided for this purpose that the handle part is guided in a form-locking manner on the carrier element at the assembly. This achieves the same advantages as described above in connection with the handle device according to the invention. In order to avoid repetition, this is referred to in full in the present case.

Furthermore, the method may provide that the handle part can be at first guided in a form-locking manner and then can be fixed to the carrier element in an end assembling position at least once, in particular twice, in a form- and/or force-locking manner. It is advantageous that a form-locking guide of the handle part can be achieved at the assembly in a predetermined track. This simplifies the assembly and allows the correct insertion direction of the handle part into the carrier element to be specified. In order to enable the installer to recognize the correct end assembling position of the external door handle, the end assembling position can be fixed for the first time in a form- and/or force-locking manner, which provides the installer with a clearly tactile feedback about reaching the end assembling position. In order to reach this end position, the installer has to overcome a small guiding resistance once again in order to fix the end assembling position for the first time in a form- and/or force-locking manner. Based on the tactile feedback, the installer then knows that he has reached the correct end assembling position and, from inside the door, can mechanically secure the handle part with the carrier element by means of a securing element, wherein the handle part can be fixed once again, i.e. for the second time, with a form- and/or force-locking manner. Thus, the handle part can not only be fixed to the carrier element in a loss-proof manner, but also secured against unauthorized and/or unintentional pulling out.

Further measures and advantages as well as technical features of the invention result from the claims, the following description and the figures. Different features can be advantageous on their own and in any combination without leaving the scope of the invention. In the following figures, the handle device according to the invention is shown in detail in several embodiments. The figures show:

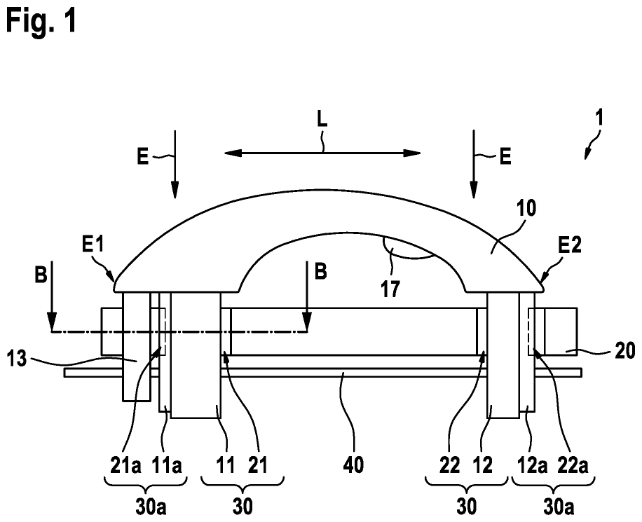

FIG. 1 a schematic representation of a longitudinal section of a handle device according to the invention,

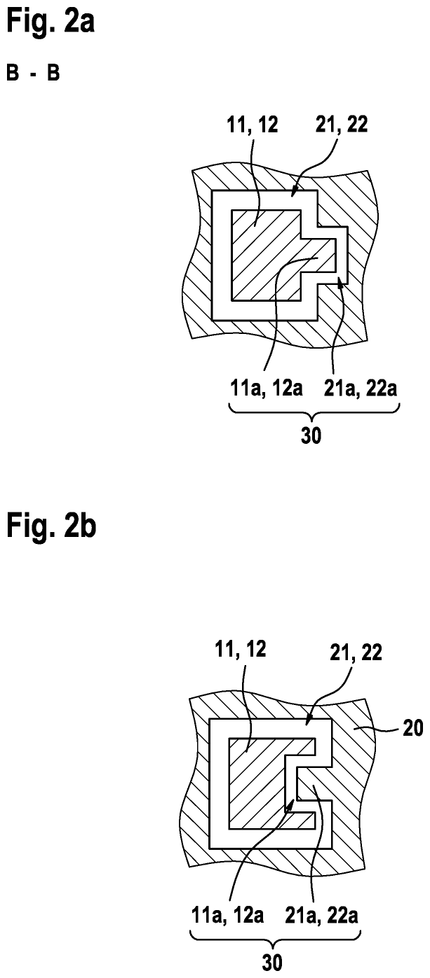

FIG. 2a a schematic representation of a possible design of the handle device according to the invention in a cross-section to a holding means,

FIG. 2b a schematic representation of a further possible design of the handle device according to the invention in cross-section to the holding means,

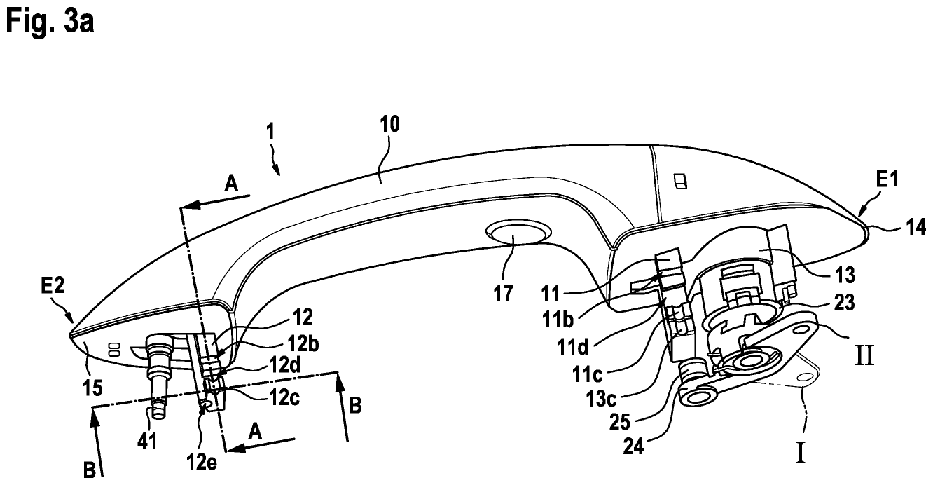

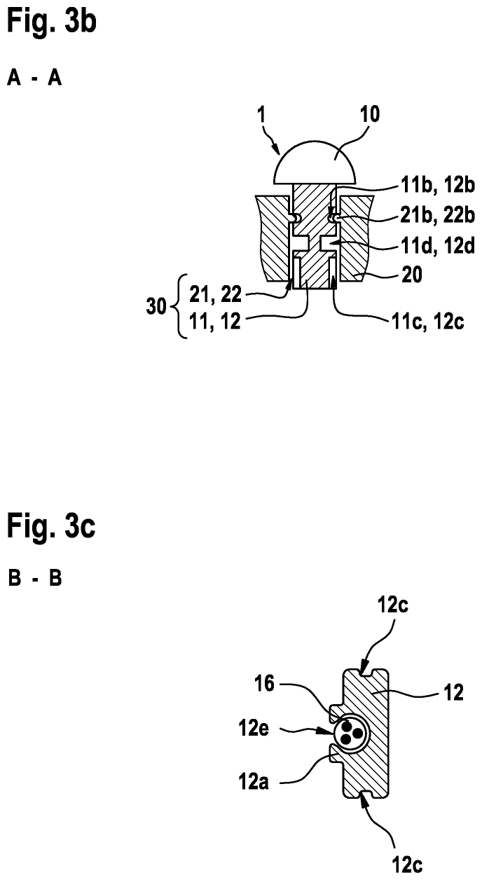

FIG. 3a a perspective representation of the handle device according to the invention according to an alternative embodiment,

FIG. 3b a schematic representation of the handle device according to the invention according to the alternative embodiment of FIG. 3a in a longitudinal section along the holding means,

FIG. 3c a cross section of a second holding means according to the invention in a cutting direction,

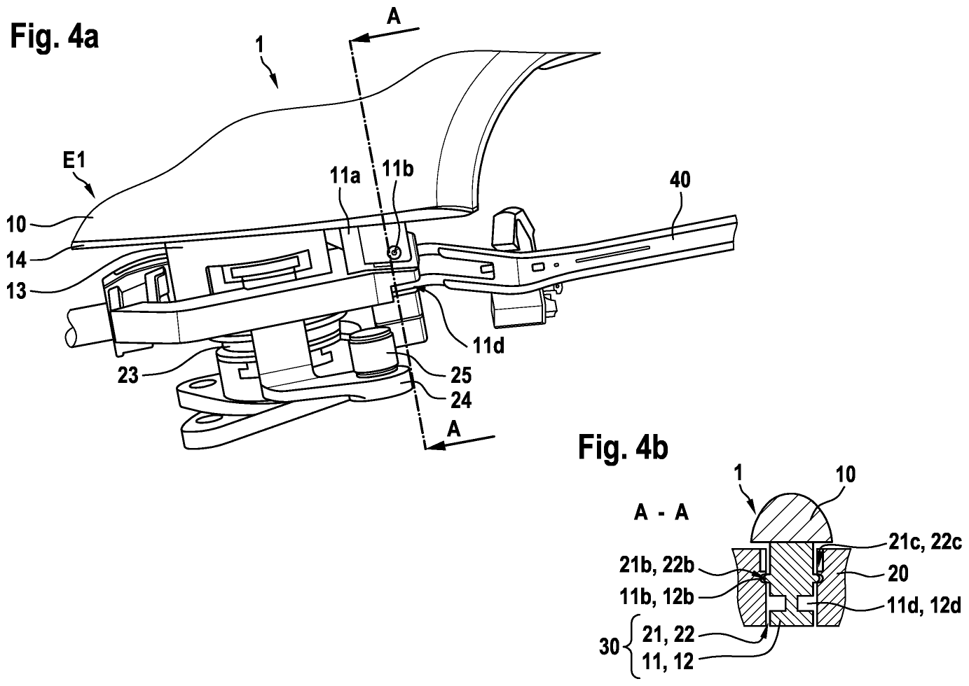

FIG. 4a a perspective representation of the handle device according to the invention according to a further alternative embodiment,

FIG. 4b a schematic representation of the handle device according to the invention according to the alternative embodiment of FIG. 4a in a longitudinal section along the holding means, and

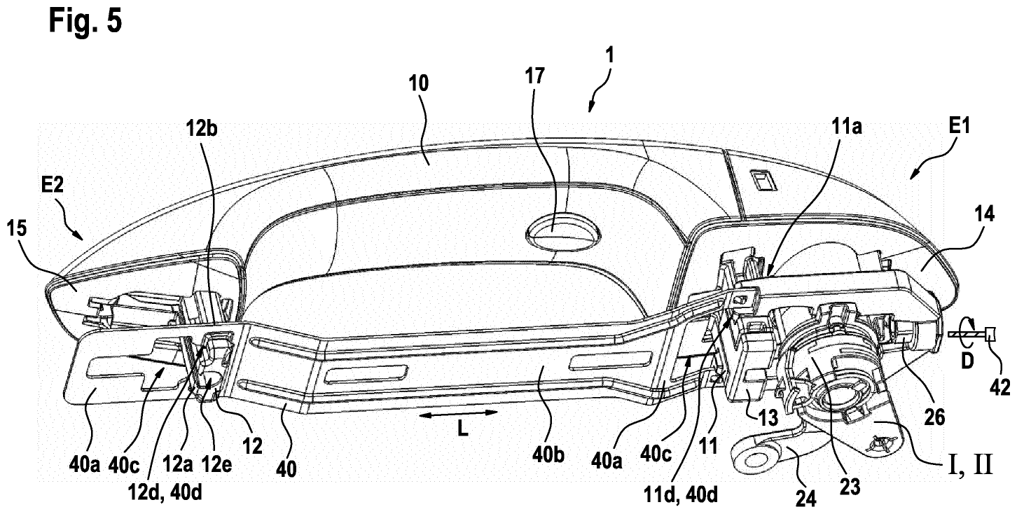

FIG. 5 a perspective representation of the handle device according to the invention with a securing element.

In the following figures, identical reference signs are used for the same technical features even from different embodiments.

FIG. 1 shows a handle device 1 according to the invention for a movable part, in particular a door or a lid, of a motor vehicle, wherein the motor vehicle and the movable part as a whole are not shown for reasons of simplicity. The handle device 1 is designed with a preferably fixed handle part 10 for actuating the movable part and a carrier element 20 for fixing the handle part 10 to the movable part. The handle part 10 is arranged on the outside and the carrier element 20 on the inside of the movable part. By fixing the handle part 10 to the carrier element 20, the handle device 1 is assembled to the movable part. According to the invention, at least one guiding unit 30 is provided between the handle part 10 and the carrier element 20 in order to guide the handle part 10 in a form-locking manner at the assembly on the carrier element 20.

According to the invention, the guiding unit 30 is integrated in the handle device 1 in order to guide the handle part 10 in a controlled manner in a predetermined track 30a in the carrier element 20 at the assembly on the carrier element 20. According to the invention, the advantage of the guiding unit 30 is on the one hand that the guiding unit 30 provides an insertion direction E for a correct insertion movement of the handle part 10 into the carrier element 20. Another advantage of the guiding unit 30 is that the guiding unit 30 guides the handle part 10 along the correct insertion direction E in a form-locking manner so that the handle part 10 cannot tip to the side. Thus, if the handle part 10 can be easily inserted into the carrier element 20, the installer receives a tactile feedback signaling that the insertion direction E is correctly selected and that he can continue with the assembly of the handle part 10.

As FIG. 1 also shows, the guiding unit 30 of the invention creates a linear guide 30a for the handle part 10 on the carrier element 20. The linear guide 30a can be provided for at least one end of the handle part E1 or E2 of the handle part 10. In the embodiment shown in FIG. 1, a linear guide 30a is provided for both ends E1, E2 of handle part 10. This can considerably improve and in particular simplify the assembly of the handle part 10 to the carrier element 20. For this purpose, the handle part 10 can be inserted into the carrier element 20 simultaneously with both ends E1, E2 in only one assembling step and with the aid of only one insertion movement in a correct insertion direction E perpendicular to its extension direction L. The installer can monitor the correctness of the assembly in a tactile way, if the handle part 10 encounters little resistance in the preferably linear guide 30a during the insertion movement 20.

In the embodiment shown in FIG. 1, the handle part 10 comprises a first holding means 11 and a second holding means 12 at opposite ends E1, E2 over its longitudinal extension L. The first holding means 11 and the second holding means 12 serve for the mechanical fixing of the handle part 10 to the carrier element 20. Complementary to the first holding means 11 and the second holding means 12, corresponding openings are provided in the carrier element 20 as bearing positions 21, 22 in which the first holding means 11 and the second holding means 12 can be received. The first holding means 11 and the second holding means 12 are designed as linear projections or pins at the opposite ends E1, E2 of the handle part 10, which project in the same direction from the handle part 10 and are aligned essentially parallel to each other.

The carrier element 20 comprises a first bearing position 21 for the first holding means 11 of the handle part 10 and a second bearing position 22 for the second holding means 12 of the handle part 10. Together, the first bearing position 21 and the first holding means 11 as well as the second bearing position 22 and the second holding means 12 form the guiding unit 30. This comprises the advantage that the functionality of the handle device 1 can be extended with only a few means, wherein the first bearing position 21 and the first holding means 11 as well as the second bearing position 22 and the second holding means 12 as a part of the guiding unit 30 not only contribute to the fixing of the handle part 10 to the carrier element 20, but also to a simple, fast and correct assembly of the handle device 1 to the movable part.

The guiding unit 30 further comprises an assembling means 11a, 12a on the first holding means 11 and on the second holding means 12 of the handle part 10, respectively. The assembling means 11a, 12a serves to produce a form-locking linear guide 30a with one guiding means 21a, 22a each on the first bearing position 21 and on the second bearing position 22 of the carrier element 20.

As shown in FIG. 2a in a cross section transverse to the first holding means 11 or the second holding means 12 in a cutting direction B, the assembling means 11 a, 12a on the first holding means 11 and on the second holding means 12 may be in the form of protruding ribs. Complementary to this, the guiding means 21a, 22a on the first bearing position 21 and on the second bearing position 22 of the carrier element 20 can be designed as guiding receptacles. Together, the assembling means 11a, 12a in the form of protruding ribs and the guiding means 21a, 22a in the form of guiding receptacles form a form-locking linear guide 30a of the guiding unit 30.

FIG. 2b shows another possible example of a form-locking linear guide 30a in the sense of the invention. FIG. 2b also shows a cross-sectional view of the first holding means 11 or the second holding means 12 in a cutting direction B. The assembling means 11a, 12a on the first holding means 11 and on the second holding means 12 can be designed as guiding receptacles. Complementary to this, the guiding means 21a, 22a can be designed as guiding rails at the first bearing position 21 and at the second bearing position 22 of the carrier element 20. Together, the assembling means 11a, 12a in the form of guiding receptacles and the guiding means 21a, 22a in the form of guiding rails form a form-locking linear guide 30a of the guiding unit 30.

In principle, it is conceivable within the scope of the invention that the holding means 11, 12 on the handle part 10 may be designed to fit exactly to the openings at the bearing positions 21, 22 of the carrier element 20 in order to directly realize a form-locking guide 30a. A form-locking guide 30a is, however, easier and more reliable to realize by means of the specially designed assembling means 11a, 12a and guiding means 21a, 22a, since the holding means 11, 12 can be designed in their entirety with a certain clearance to the openings at the bearing positions 21, 22 in order to counteract tolerances in the production of the elements of the handle device 1 or as a result of material properties.

FIGS. 3a and 4a each show a possible embodiment of the handle device 1 according to the invention in a perspective representation with one engaging means 11b, 12b each on the first holding means 11 and on the second holding means 12 of the handle part 10. The engaging means 11b, 12b serve to fix an end assembling position of the handle part 10 on the carrier element 20 in a form- and/or force-locking manner. This enables the installer to recognize the correct end assembling position of the handle part 10 on the carrier element 20 when the engaging means 11b, 12b snap into specially designed fixing means 21b, 22b at the first bearing position 21 and at the second bearing position 22 of the carrier element 20 when the end assembling position is reached. The fixing means 21b, 22b are shown in detail in the following FIGS. 3b and 4b, which show the holding means 11, 12 in a longitudinal section along a cutting direction A.

FIGS. 3a and 3b show a possible embodiment of the engaging means 11b, 12b on the first holding means 11 and on the second holding means 12 of the handle part 10 in the form of engaging receptacles. Complementary to this, the fixing means 21b, 22b at the first bearing position 21 and at the second bearing position 22 of the carrier element 20 can be designed in the form of fixing cams. Together, the engaging means 11b, 12b in the form of engaging receptacles and the fixing means 21b, 22b in the form of fixing cams form a form-and/or force-locking connection.

FIGS. 4a and 4b show a further possible embodiment of the engaging means 11b, 12b on the first holding means 11 and on the second holding means 12 of the handle part 10 in the form of engaging cams. Complementary to this, the fixing means 21b, 22b can be designed in the form of fixing receptacles at the first bearing position 21 and at the second bearing position 22 of the carrier element 20. Together, the engaging means 11b, 12b in the form of engaging cams and the fixing means 21b, 22b in the form of fixing receptacles form a form- and/or force-locking connection.

FIG. 3c further shows that at least one assembling means 12a, e.g. on the second assembling means 12, of the handle part 10 can comprise a bore 12e, which can serve as a cable holder. FIG. 3c shows a cross section of the second holding means 12 in a cutting direction B. The bore 12e can extend along the entire assembling means 12a and can receive at least one cable 16 in a protected way. The cable 16 can lead to a sensor element 17 on the handle part 10, which can be used to actuate the movable part, e.g. to open the movable part. Thus, the assembling means 12a can not only ensure a form-locking guide of the handle part 10 in the carrier element 20, but also fulfill another important function, namely a protected guidance of at least one cable 16 from the inside of the handle device 1 behind the movable part to the outside handle part 10.

As FIGS. 3a, 3b, 4a and 4b also show, the guiding unit 30 is provided with pre-engaging means 11c, 12c, 21c, 22c on the first holding means 11 and on the second holding means 12 of the handle part 10 (see FIGS. 3a and 3b) or on the first bearing position 21 and on the second bearing position 22 of the carrier element 20 (see FIGS. 4a and 4b) in order to guide the respective fixing means 21b, 22b on the first bearing position 21 and on the second bearing position 22 of the carrier element 20 (see FIGS. 3a and 3b) or the respective engaging means 11b, 12b on the first holding means 11 and on the second holding means 12 of the handle part 10 (see FIGS. 4a and 4b) at the assembly of the handle part 10 to the carrier element 20 in a form-locking manner before the end assembling position of the handle part 10 to the carrier element 20 is reached as shown in FIGS. 3b and 4b. The pre-engaging means 11c, 12c, 21c, 22c are used to ensure that during the insertion movement of the handle part 10 into the carrier element 20, the respective engaging means 11b, 12b on the first holding means 11 and on the second holding means 12 of the handle part 10 (see FIGS. 4a and 4b) or the respective fixing means 21b, 22b at the first bearing position 21 and at the second bearing position 22 of the carrier element 20 (see FIGS. 3a and 3b) do not initially interfere with a form-locking guide of the handle part 10 on the carrier element 20 by the linear guide 30a shown in FIGS. 1, 2a and 2b. Shortly before reaching an end assembling position of the handle part 10 on the carrier element 20, the pre-engaging means 11c, 12c, 21c, 22c ends, thus creating a guiding resistance for the engaging means 11b, 12b or for the fixing means 21b, 22b. In the end assembling position, this means that the engaging means 11b, 12b and the fixing means 21b, 22b can be brought into a form- and/or force-locking connection when the guiding resistance is released. The installer experiences a snap movement as a haptic feedback that signals the end assembling position. Based on the haptic feedback, the installer then knows that he has reached the correct end assembling position and can secure the handle part 10 with the carrier element 20 mechanically from the inside of the door using a securing element 40, as explained below in FIG. 5.

As further shown in FIGS. 3a and 4a, a locking cylinder 23 can be provided at one end E1 of the handle part 10 to actuate the movable part mechanically. In addition, a reinforcing element 13 for the locking cylinder 23 may be provided on the handle part 10 to protect the locking cylinder 23 against mechanical manipulation from the outside, i.e. from the side of the handle part 10. The reinforcing element 13 can be designed in the form of a solid collar element for the locking cylinder 23. The reinforcing element 13 can be clamped from the side of the first holding means 11 of the handle part 10 in order to be fixed to the handle part 10. The pre-engaging means 11c on the first holding means 11 can thereby transfer into a pre-engaging means 13c on the reinforcing element 13 to guide a guide of a complementary fixing cam 21b in the first bearing position 21 on the carrier element 20 shortly before reaching the end assembling position of the handle part 10. The locking cylinder 23 can comprise at least a first closed position I and a second closed position II to actuate a lock on the movable part and to open or close the movable part. In the case of a fixed handle part 10, the locking cylinder 23 can act directly and mechanically on a locking pawl in the door lock without actuating the handle. Furthermore, an extension 24 for a bearing bush 25 can be provided on the locking cylinder 23. FIGS. 3a and 4a schematically show two closed positions I, II of the locking cylinder 23.

In addition, the first end E1 and the second end E2 of the handle part 10 can each be provided with a sealing 14, 15, which can protect the inside of the handle part 10 from moisture and dirt.

In addition, as shown in FIGS. 3a, 3b, 4a and 4b, the first holding means 11 and the second holding means 12 of the handle part 10 are each provided with connecting means 11d, 12d which can interact with a securing element 40 shown in FIG. 5 to secure the handle part 10 in the end assembling position on the carrier element 20. In addition, FIGS. 3a, 3b, 4a and 4b show a screw 41 for the securing element 40 which, when the securing element 40 is displaced along the longitudinal direction L, can stabilize the movement of the securing element 40 and/or serve as a stop in an end position of the securing element 40.

Finally, FIG. 5 shows the handle part 10 in a fixed end assembling position on the carrier element 20, which is secured by the securing element 40 against forced removal of the handle part 10. For this purpose, the securing element 40 can be displaced in a longitudinal direction L by means of an adjusting screw 42. The adjusting screw 42 can be tightened by turning it in a rotation direction D in relation to a screw nut 26 which is fixedly received in the carrier element 20. The securing element 40 can be designed in the middle in the form of a securing plate 40b and at the end in the form of a securing fork 40a for the respective holding means 11, 12 on the handle part 10.

When the securing element 40 is displaced along the longitudinal direction L from left to right, a wider assembling opening 40c for the respective holding means 11, 12 at one fork-like end of the securing element 40 in each case can transfer into a narrower securing opening 40d, in which in each case a connecting means 11d, 12d of the first holding means 11 and the second holding means 12 of the handle part 10 can engage in a form-locking manner. Afterwards, it is no longer possible to pull out the handle part 10 perpendicular to the extension direction L of the securing element 40, because the securing element 40 stands in the way of such a movement. Consequently, the securing element 40 can prevent that the handle part 10 can be pulled out unauthorized and/or unintentionally along the form-locking guide 30a of the guiding unit 30, which was created for the assembly. This provides a simple, secure handle device 1 which is also easy to assemble.

The above explanation of the embodiments describes the present invention exclusively in the context of examples. Of course, individual features of the present invention can be freely combined with each other, if technically reasonable, without leaving the scope of the present invention/claims.

### LIST OF REFERENCE SIGNS

1 handle device
10 handle part
11 first holding means
11a assembling means
11b engaging means
11c pre-engaging means
11d connecting means
12 second holding means
12a assembling means
12b engaging means
12c pre-engaging means
12d connecting means
12e bore
13 reinforcing element
13c pre-engaging means
14 sealing
15 sealing
16 cable
17 sensor element
20 carrier element
21 first bearing position
21a guiding means
21b fixing means
21c pre-engaging means
22 second bearing position
22a guiding means
22b fixing means
22c pre-engaging means
23 locking cylinder
24 extension on the locking cylinder for a bearing bush
25 bearing bush
26 screw nut
30 guiding unit
30a predetermined track, linear guide
40 securing element
40a securing fork
40b securing plate
40c assembling opening
40d securing opening
41 screw
42 adjusting screw
A cutting direction along the first holding means
B cutting direction transverse to the first holding means
D rotation direction of the adjusting screw
E1 end of the handle part
E2 end of the handle part
L extension direction, longitudinal direction
E insertion direction
I first closed position
II second closed position

1-17. (canceled)

18. A handle device for a movable part of a motor vehicle, comprising:
a handle part for actuating the movable part,
and a carrier element for fixing the handle part to the movable part,
wherein
at least one guiding unit is provided between the handle part and the carrier element in order to guide the handle part in a form-locking manner at the assembly on the carrier element.

19. The handle device according to claim 18,
wherein
the guiding unit forms a linear guide for the handle part at the assembly on the carrier element.

20. The handle device according to claim 18,
wherein
the handle part comprises a first holding means and a second holding means at opposite ends over its longitudinal extension.

21. The handle device according to claim 18,
wherein
the carrier element comprises a first bearing position for the first holding means of the handle part and a second bearing position for the second holding means of the handle part.

22. The handle device according to claim 18,
wherein
the guiding unit comprises at least one assembling means on at least the first holding means or on the second holding means of the handle part.

23. The handle device according to claim 18,
wherein
the guiding unit comprises at least one guiding means at at least the first bearing position or at the second bearing position of the carrier element.

24. The handle device according to claim 18,
wherein
the assembling means comprises a bore on at least the first holding means or on the second holding means of the handle part which serves as a cable holder.

25. The handle device according to claim 18,
wherein
the guiding unit comprises at least one engaging means on at least the first holding means or on the second holding means of the handle part in order to fix an end assembling position of the handle part on the carrier element in at least a form- or force-locking manner.

26. The handle device according to claim 18,
wherein
the guiding unit comprises at least one fixing means at at least the first bearing position or at the second bearing position of the carrier element.

27. The handle device according to claim 18,
wherein
the guiding unit comprises at least one pre-engaging means at least on the first holding means or on the second holding means of the handle part or on the first bearing position or on the second bearing position of the carrier element in order to guide at least the fixing means at least on the first bearing position or on the second bearing position of the carrier element or the engaging means on at least the first holding means or on the second holding means of the handle part in a form-locking manner at the assembly of the handle part on the carrier element, before the end assembling position of the handle part on the carrier element is reached.

28. The handle device according to claim 18,
wherein
the handle part comprises at least one connecting means which interacts with a securing element in order to secure the handle part in an end assembling position of the handle part on the carrier element.

29. The handle device according to claim 18,
wherein
a securing element is provided which serves to secure the handle part in an end assembling position on the carrier element.

30. The handle device according to claim 18,
wherein
a locking cylinder is provided on the carrier element in order to actuate the movable part mechanically.

31. The handle device according to claim 18,
wherein
the handle device is designed as a part of a locking system of the motor vehicle.

32. A method for assembling a handle device for a movable part of a motor vehicle,
which is designed with
a handle part for actuating the movable part,
and a carrier element for fixing the handle part to the movable part,
wherein
the handle part is guided in a form-locking manner on the carrier element at the assembly.

33. The method according to claim 32,
wherein
the handle part is at first guided in a form-locking manner and is then fixed to the carrier element in an end assembling position at least once in at least a form- or force-locking manner.
